(19) United States
(12) Patent Application Publication
(10) Pub. No.: US 2024/0124343 A1
(43) Pub. Date: Apr. 18, 2024

(54) Slit Cutter

(71) Applicant: Vitro Flat Glass LLC, Cheswick, PA (US)

(72) Inventor: Thomas L. Waterloo, Cheswick, PA (US)

(21) Appl. No.: 18/380,037

(22) Filed: Oct. 13, 2023

Related U.S. Application Data
(60) Provisional application No. 63/416,209, filed on Oct. 14, 2022.

(51) Int. Cl. C03B 33/03; C03B 33/10

(52) U.S. Cl. CPC C03B 33/03; C03B 33/107

(57) ABSTRACT

In one embodiment or aspect of the present disclosure, a glass slit cutter may include a body, a cutting wheel extending from the body and configured to cut a slit in a pane of glass, a reference wheel extending from the body and configured to guide the cutting wheel along the pane of glass. The cutting wheel and the reference wheel rotate about a common axis within the body.

### CROSS REFERENCE TO RELATED APPLICATION

This application claims priority to U.S. Provisional Application No. 63/416,209, filed on Oct. 14, 2022, the disclosure of which is incorporated by reference in its entirety.

### BACKGROUND OF THE INVENTION

### Field of the Invention

The present invention relates to a glass slit cutter for cutting glass and methods of cutting glass using the slit cutter.

### Description of Related Art

Glass ribbons are typically cut and trimmed using slit cutters as the glass ribbons move along a cutting roll. Numerous variables of slit cutters are controlled to cut and trim the glass to achieve trade glass cutting specifications. For instance, the speed of the cutter to the glass and the wheel cutter movement in space can be controlled to cut and trim the glass to achieve desired trade glass cutting specifications. However, various issues arise in known slit cutters including mechanical tolerance and component clearance issues. Thus, it is desirable to provide an improved slit cutter that overcomes these drawbacks while also being able to achieve trade glass cutting specifications.

### SUMMARY OF THE INVENTION

In one embodiment or aspect of the present disclosure, a glass slit cutter may include a body, a cutting wheel extending from the body and configured to cut a slit in a pane of glass, a reference wheel extending from the body and configured to guide the cutting wheel along the pane of glass. The cutting wheel and the reference wheel rotate about a common axis within the body.

A ball bearing axle may extend through the body. The cutting wheel and the reference wheel may rotate about the ball bearing axle. The body may include a first portion and a second portion defining an operating channel therebetween, and the cutting wheel may extend from the first portion, and from the body within the operating channel. The ball bearing axle may extend through the first portion of the body, the operating channel, and the second portion of the body. The slut cutter may further include a solenoid located proximate to the second portion of the body, and the solenoid may be configured to power the cutting wheel. The ball bearing axle may extend through at least a portion of the solenoid so that the solenoid rotates about the ball bearing axle.

The slit cutter may further include a force applicator configured to apply a force to the cutting wheel via power received from the solenoid. The force applicator may be an air spring. The slit cutter may further include a bracket, and a first end of the bracket may be connected to the cutting wheel, and a second end of the bracket may be connected to the reference wheel such that rotation of the cutting wheel is synchronous with the rotation of the reference wheel. The slit cutter may further include a cutting wheel cantilever. A first end of the cutting wheel cantilever may be mounted to the ball bearing axle. The cutting wheel may extend proximate a second end of the cutting wheel cantilever. The cutting wheel cantilever and the cutting wheel may be rotatable about the ball bearing axle. The slit cutter may further include a force applicator configured to apply a force to the cutting wheel, and the force applicator may be mounted to the cutting wheel cantilever on a side opposing the cutting wheel.

The glass slit cutter may further include a reference wheel cantilever. A first end of the reference wheel cantilever may be mounted to the ball bearing axle. The reference wheel may be mounted to a second end of the reference wheel cantilever. The reference wheel cantilever and the reference wheel may be rotatable about the ball bearing axle. The glass slit cutter may further include an arm extending from the body, the arm being mounted to the second end of the reference wheel cantilever such that the arm is retractable within the body in order to rotate the reference wheel cantilever about the ball bearing axle. The arm may include an air cylinder for retracting and extending the arm within the body.

In another embodiment or aspect of the present disclosure, a glass slit cutter may include a body having a first portion and a second portion, the first portion and the second portion defining an operating channel therebetween, a reference wheel mounted to the first portion of the body, the reference wheel being retractable within the first portion of the body, a cutting wheel mounted to the body, at least partially extending through the operating channel, and being retractable within the operating channel, and a ball bearing axle extending through the body such that the reference wheel and the cutting wheel are rotatable about the ball bearing axle.

The glass slit cutter may further include a bracket having a first end mounted to the reference wheel and a second end mounted to the cutting wheel such that rotation of the cutting wheel is synchronous with the rotation of the reference wheel. The glass slit cutter may further include a force applicator configured to provide a cutting force to the cutting wheel. The glass slit cutter may further include a solenoid to provide power to the force applicator. The solenoid may be connected to the ball bearing axle. The solenoid may be mounted to the second portion of the body. The glass slit cutter may further include a cutting wheel cantilever having a first end mounted to the ball bearing axle and a second end. The cutting wheel may be mounted to the cutting wheel cantilever proximate the second end, and the force applicator is mounted to the cutting wheel cantilever proximate the second end on a side opposing the cutting wheel.

In some embodiments or aspects, the present disclosure can be represented by the following clauses:

Clause 1. A glass slit cutter comprising: a body; a cutting wheel extending from the body and configured to cut a slit in a pane of glass; a reference wheel extending from the body and configured to guide the cutting wheel along the pane of glass, wherein the cutting wheel and the reference wheel rotate about a common axis within the body.

Clause 2. The glass slit cutter of clause 1, further comprising a ball bearing axle extending through the body, wherein the cutting wheel and the reference wheel rotate about the ball bearing axle.

Clause 3. The glass slit cutter of clause 2, wherein the body comprises a first portion and a second portion defining an operating channel therebetween, and wherein the cutting wheel extends from the first portion, and the cutting wheel extends from the body within the operating channel.

Clause 4. The glass slit cutter of clause 3, wherein the ball bearing axle extends through the first portion of the body, the operating channel, and the second portion of the body.

Clause 5. The glass slit cutter of clause 3 or 4, further comprising a solenoid located proximate to the second portion of the body, the solenoid configured to power the cutting wheel, wherein the ball bearing axle extends through at least a portion of the solenoid so that the solenoid rotates about the ball bearing axle.

Clause 6. The glass slit cutter of clause 5, further comprising a force applicator configured to apply a force to the cutting wheel via power received from the solenoid.

Clause 7. The glass slit cutter of clause 6, wherein the force applicator is an air spring.

Clause 8. The glass slit cutter of any of clauses 2-7, further comprising a bracket, wherein a first end of the bracket is connected to the cutting wheel, and a second end of the bracket is connected to the reference wheel such that rotation of the cutting wheel is synchronous with the rotation of the reference wheel.

Clause 9. The glass slit cutter of any of clauses 2-8, further comprising a cutting wheel cantilever, wherein a first end of the cutting wheel cantilever is mounted to the ball bearing axle, wherein the cutting wheel extends proximate a second end of the cutting wheel cantilever, and wherein the cutting wheel cantilever and the cutting wheel are rotatable about the ball bearing axle.

Clause 10. The glass slit cutter of clause 9, further comprising a force applicator configured to apply a force to the cutting wheel, wherein the force applicator is mounted to the cutting wheel cantilever on a side opposing the cutting wheel.

Clause 11. The glass slit cutter of any of clauses 2-10, further comprising a reference wheel cantilever, wherein a first end of the reference wheel cantilever is mounted to the ball bearing axle, wherein the reference wheel is mounted to a second end of the reference wheel cantilever, and wherein the reference wheel cantilever and the reference wheel are rotatable about the ball bearing axle.

Clause 12. The glass slit cutter of clause 11, further comprising an arm extending from the body, the arm being mounted to the second end of the reference wheel cantilever such that the arm is retractable within the body in order to rotate the reference wheel cantilever about the ball bearing axle.

Clause 13. The glass slit cutter of clause 12, wherein the arm comprises an air cylinder for retracting and extending the arm within the body.

Clause 14. A glass slit cutter comprising: a body comprising a first portion and a second portion, the first portion and the second portion defining an operating channel therebetween; a reference wheel mounted to the first portion of the body, the reference wheel being retractable within the first portion of the body; a cutting wheel mounted to the body, at least partially extending through the operating channel, and being retractable within the operating channel; and a ball bearing axle extending through the body such that the reference wheel and the cutting wheel are rotatable about the ball bearing axle.

Clause 15. The glass slit cutter of clause 14, further comprising a bracket having a first end mounted to the reference wheel and a second end mounted to the cutting wheel such that rotation of the cutting wheel is synchronous with the rotation of the reference wheel.

Clause 16. The glass slit cutter of clause 14 or 15, further comprising a force applicator configured to provide a cutting force to the cutting wheel.

Clause 17. The glass slit cutter of clause 16, further comprising a solenoid to provide power to the force applicator.

Clause 18. The glass slit cutter of clause 17, wherein the solenoid is connected to the ball bearing axle.

Clause 19. The glass slit cutter of clause 18, wherein the solenoid is mounted to the second portion of the body.

Clause 20. The glass slit cutter of any of clauses 16-19, further comprising a cutting wheel cantilever having a first end mounted to the ball bearing axle and a second end, wherein the cutting wheel is mounted to the cutting wheel cantilever proximate the second end, and the force applicator is mounted to the cutting wheel cantilever proximate the second end on a side opposing the cutting wheel.

### BRIEF DESCRIPTION OF THE DRAWING(S)

FIG. 1 is a front transparent view of a body of a slit cutter and a reference wheel according to one embodiment or aspect of the present disclosure;

FIG. 2 is a front transparent view of a glass slit cutter and a reference wheel according to one embodiment or aspect of the present disclosure;

FIG. 3 is a side view of the cutting wheel shown in FIG. 2;

FIG. 4 is a side view showing the movement of the cutting wheel shown in FIG. 2 within the body of the slit cutter;

FIG. 5 is a side view of the reference wheel of the glass slit cutter shown in FIG. 1;

FIG. 6 is a side view showing the movement of the reference wheel shown in FIG. 1 within the body of the slit cutter; and

FIG. 7 is a side view of a solenoid for a slit cutter according to one embodiment or aspect of the present disclosure.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

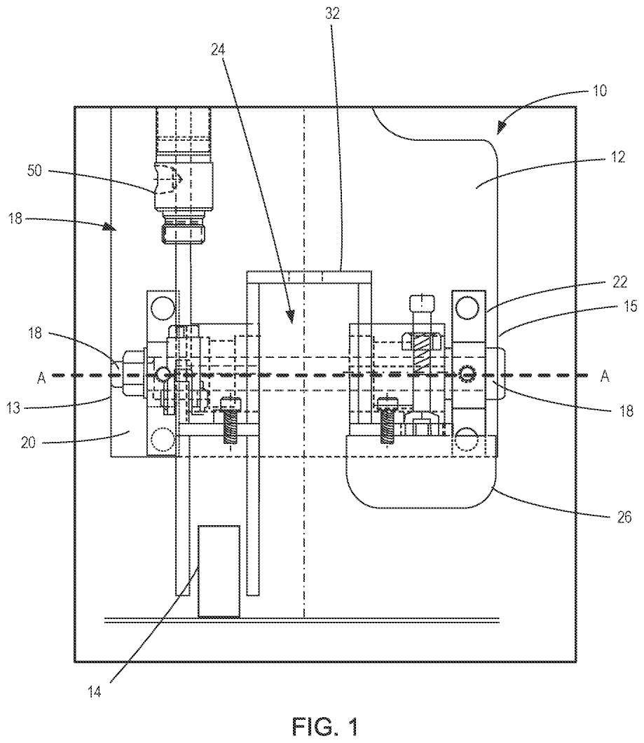

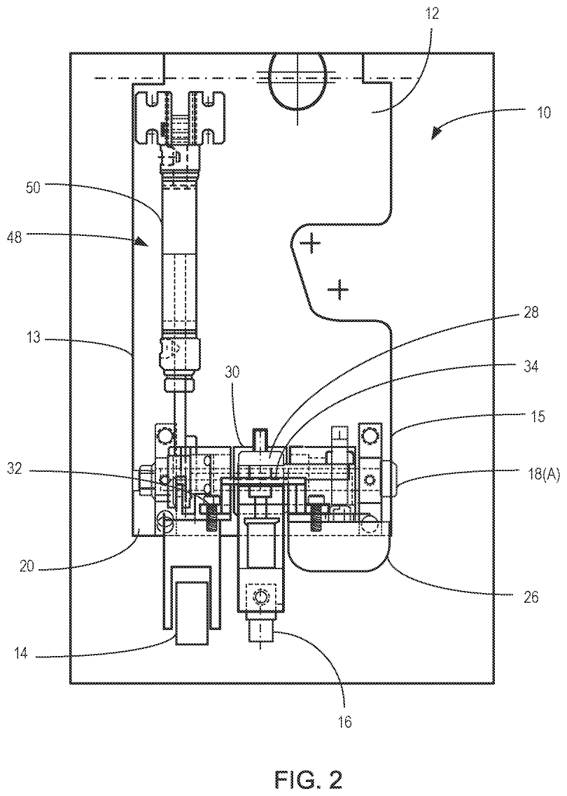

The present disclosure is directed toward a glass slit cutter 10. FIGS. 1 and 2 show the slit cutter 10, which includes a body 12, a reference wheel 14, and a cutting wheel 16 (shown in FIG. 2). The body 12 houses the various elements used to operate the slit cutter 10. The reference wheel 14 guides the slit cutter 10 along a pane of glass G. The cutting wheel 16 cuts the glass G according to a desired specification. The reference wheel 14 and cutting wheel 16 share a common axis A so that they can rotate relative to the body 12 synchronously. This allows for smaller tolerances between these two features in operation, which results in a more precise cutting operation. In one embodiment, the reference wheel 14 and cutting wheel 16 can be mounted to a ball bearing axle 18 that extends through the body 12. The arrangement and rotation of the reference wheel 14 and cutting wheel 16 about the ball bearing axle 18 will be described in greater detail.

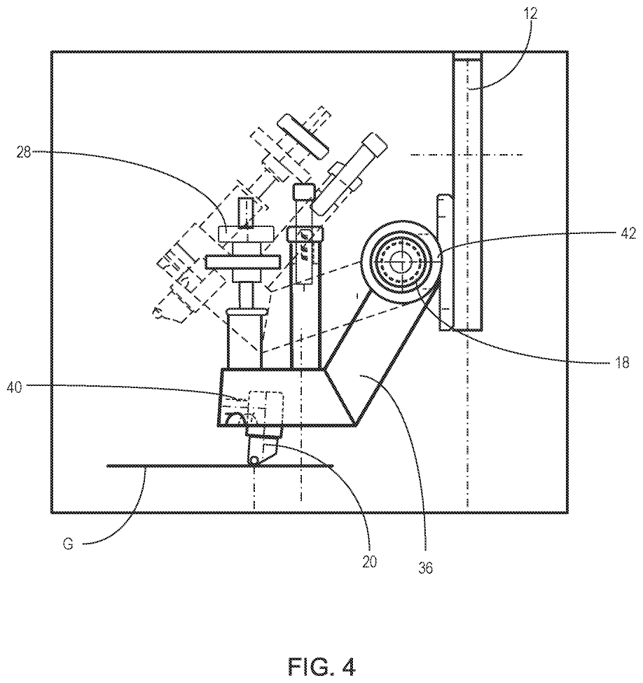

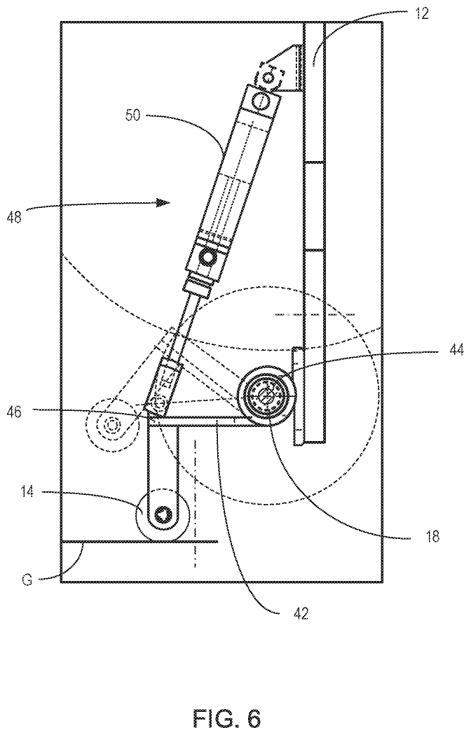

As shown in FIGS. 1 and 2, the body 12 includes a first portion 20 and a second portion 22, both extending toward the glass G. The reference wheel 14 extends from the first portion 20, with some of the features associated with its operation being held within the first portion 20. The first portion 20 and the second portion 22 define an operating channel 24 therebetween. The cutting wheel 16 extends and operates within the operating channel 24. The ball bearing axle 18 extends through the body generally perpendicular to the direction in which the reference wheel 14 and the cutting wheel 16 extend. A first end of the ball bearing axle 18 is mounted to a sidewall 13 of the body proximate the first portion 20, and a second end of the ball bearing axle 18 is mounted to a sidewall 15 of the body 12 proximate the second portion 22. The ball bearing axle 18 may also extend through the operating channel 24. This arrangement allows an end of the reference wheel 14 and an end of the cutting wheel 16 to be mounted to the ball bearing axle 18, so that both the reference wheel 14 and the cutting wheel rotate about the ball bearing axle 18. FIGS. 4 and 6 show this rotation. By being rotatable about the ball bearing axle 18 in this manner, the tolerances of both the reference wheel 14 and the cutting wheel 16 can be minimized to allow for a more precise cutting. The rotation of the reference wheel 14 and the cutting wheel 16 may also be synchronized about the ball bearing axle 18.

It was found that the previously described slit cutter 10 arrangement provides improved mechanical tolerances and the desired clearances of each component during operation through the rotary motion of the reference wheel 14 and cutting wheel 16. For instance, the ball bearing axle 18 was found to provide a tight mechanical tolerance to reduce clearance issues of the reference wheel 14 and cutting wheel 16 during operation and by providing the rotary motion of the wheels 14 and 16. The slit cutter 10 can also provide various system capabilities. For example, in some examples, the slit cutter 10 can provide: Automotive Size Specification of +¼″- 1/16″; Appliance Grade Size Specification ± 1/32″ (e.g., GEMTRON ± 1/64″ within each container); and/or 8-2 Slit Size Capability (e.g., @± 1/32″: Cpk 1.1; @± 1/64″: Cpk 0.5).

The second portion 22 of the body 12 houses an electric solenoid 26, which ultimately provides power to the cutting wheel 16, so that it can act on the glass G. The electric solenoid 26 may provide power to a force applicator 28, which in turn acts on the cutting wheel 16, providing the force necessary to cut a slit in the glass G. In some instances, the force applicator 28 may be an air spring. The solenoid 26 can also be mounted to or otherwise linked to the ball bearing axle 18 within the second portion 22 of the body 12. It is also contemplated that power from the solenoid 26 can cause the rotation of the reference wheel 14 and cutting wheel 16. To help facilitate the synchronous rotation of these two elements, a bracket 30 may be used to connect the reference wheel 14 and cutting wheel 16. A first end 32 of the bracket 30 is mounted to the reference wheel 14, and a second end 34 of the bracket 30 is mounted to the cutting wheel 16. A portion of this bracket 30 may extend along a boundary of the operating channel 24.

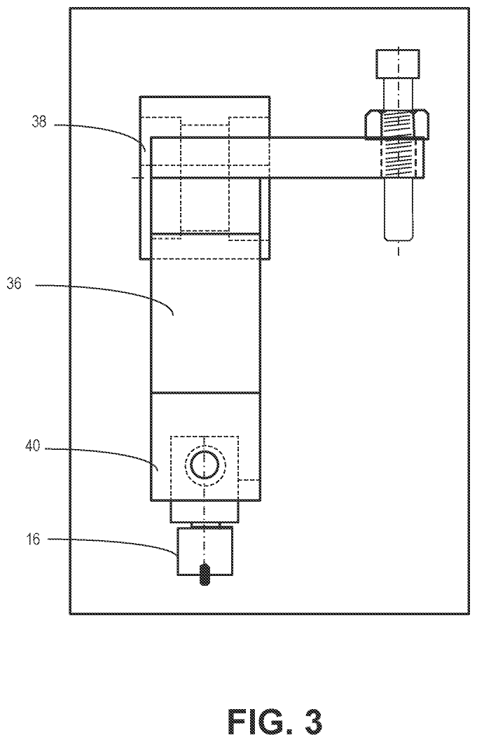

With reference to FIGS. 3 and 4, a cutting wheel cantilever 36 is shown. The cutting wheel cantilever 36 connects the cutting wheel 16 to the ball bearing axle 18. A first end 38 of the cutting wheel cantilever 36 is mounted about the ball bearing axle 18. The cutting wheel 16 is mounted to the cantilever 36 proximate a second end 40. The cutting wheel cantilever 36 extends downward from the first end 38, in a direction toward the glass G, at an angle and then extends essentially parallel to the glass G until it terminates at the second end 40. The force applicator 28 is also mounted to the cutting wheel cantilever 36 proximate the second end 40 on a side opposite that of the cutting wheel 16, so that the force applicator 28 can apply the downward force to the cutting wheel 16 in order to cut the glass G. The rotation of the cutting wheel cantilever 36, the cutting wheel 16, and the force applicator 28 about the ball bearing axle 18 is shown partially in phantom lines in FIG. 4.

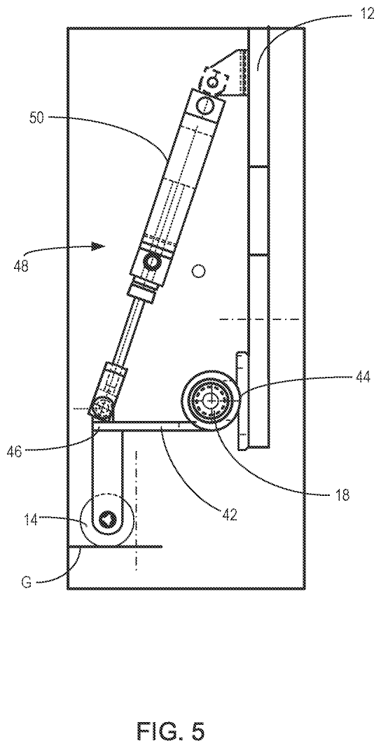

With reference to FIGS. 5 and 6, features associated with the reference wheel 14 are shown. A reference wheel cantilever 42 connects the reference wheel 14 to the ball bearing axle 18. A first end 44 of the reference wheel cantilever 42 is mounted to the ball bearing axle 18. The reference wheel 14 is mounted proximate a second end 46 of the reference wheel cantilever 42. The reference wheel cantilever 42 extends from the ball bearing axle 18 in a direction substantially parallel to the glass G, with the reference wheel 14 and its mounting features extended perpendicularly downward until the wheel 18 contacts the glass G. An arm 48 is also mounted to the reference wheel cantilever 42 proximate the second end 46. The arm 48 is mounted to a side of the cantilever 42 opposite that of the reference wheel 14. An air cylinder 50 is a part of the arm 48, and the air cylinder 50 operates to draw the reference wheel 14 upwards within the first portion 20 of the body 12 and to extend the wheel 14 downward to contact the glass G. Mounting features for the arm 48 are located proximate a top portion of the body 12, as shown in FIG. 2.

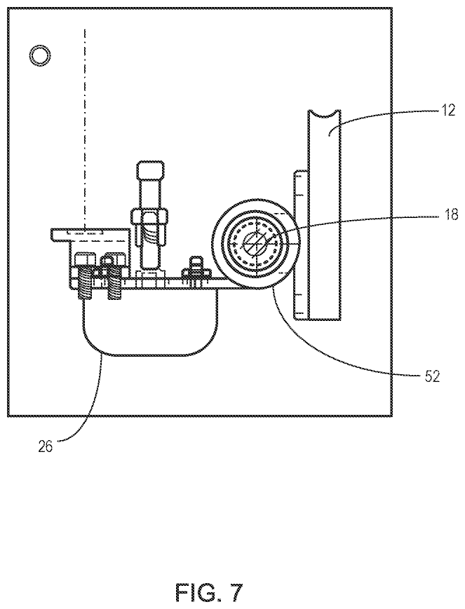

FIG. 7 shows the solenoid 26 and its associated features relative to the ball bearing bracket 18. The solenoid 26 includes a mount 52 to connect to the ball bearing axle 18.

It is appreciated that the slit cutter 10 can include additional components such as a motor, mounting wheels, air lines, and the like. The slit cutter 10 can also include a controller, and one or more computer-readable storage mediums in operable communication with the controller. The computer-readable storage mediums can contain programming instructions that, when executed, cause the controller to perform multiple tasks, such as to cause the slit cutter 10 to cut glass.

Whereas particular embodiments of this invention have been described above for purposes of illustration, it will be evident to those skilled in the art that numerous variations of the details of the present invention may be made without departing from the invention as defined in the appended claims.

The invention claimed is:

1. A glass slit cutter comprising:
a body;
a cutting wheel extending from the body and configured to cut a slit in a pane of glass;
a reference wheel extending from the body and configured to guide the cutting wheel along the pane of glass,
wherein the cutting wheel and the reference wheel rotate about a common axis within the body.

2. The glass slit cutter of claim 1, further comprising a ball bearing axle extending through the body,
wherein the cutting wheel and the reference wheel rotate about the ball bearing axle.

3. The glass slit cutter of claim 2, wherein the body comprises a first portion and a second portion defining an operating channel therebetween, and wherein the cutting wheel extends from the first portion, and the cutting wheel extends from the body within the operating channel.

4. The glass slit cutter of claim 3, wherein the ball bearing axle extends through the first portion of the body, the operating channel, and the second portion of the body.

5. The glass slit cutter of claim 4, further comprising a solenoid located proximate to the second portion of the body, the solenoid configured to power the cutting wheel
wherein the ball bearing axle extends through at least a portion of the solenoid so that the solenoid rotates about the ball bearing axle.

6. The glass slit cutter of claim 5, further comprising a force applicator configured to apply a force to the cutting wheel via power received from the solenoid.

7. The glass slit cutter of claim 6, wherein the force applicator is an air spring.

8. The glass slit cutter of claim 2, further comprising a bracket,
wherein a first end of the bracket is connected to the cutting wheel, and a second end of the bracket is connected to the reference wheel such that rotation of the cutting wheel is synchronous with the rotation of the reference wheel.

9. The glass slit cutter of claim 2, further comprising a cutting wheel cantilever,
wherein a first end of the cutting wheel cantilever is mounted to the ball bearing axle,
wherein the cutting wheel extends proximate a second end of the cutting wheel cantilever, and
wherein the cutting wheel cantilever and the cutting wheel are rotatable about the ball bearing axle.

10. The glass slit cutter of claim 9, further comprising a force applicator configured to apply a force to the cutting wheel,
wherein the force applicator is mounted to the cutting wheel cantilever on a side opposing the cutting wheel.

11. The glass slit cutter of claim 2, further comprising a reference wheel cantilever,
wherein a first end of the reference wheel cantilever is mounted to the ball bearing axle,
wherein the reference wheel is mounted to a second end of the reference wheel cantilever, and
wherein the reference wheel cantilever and the reference wheel are rotatable about the ball bearing axle.

12. The glass slit cutter of claim 11, further comprising an arm extending from the body, the arm being mounted to the second end of the reference wheel cantilever such that the arm is retractable within the body in order to rotate the reference wheel cantilever about the ball bearing axle.

13. The glass slit cutter of claim 12, wherein the arm comprises an air cylinder for retracting and extending the arm within the body.

14. A glass slit cutter comprising:
a body comprising a first portion and a second portion, the first portion and the second portion defining an operating channel therebetween;
a reference wheel mounted to the first portion of the body, the reference wheel being retractable within the first portion of the body;
a cutting wheel mounted to the body, at least partially extending through the operating channel, and being retractable within the operating channel; and
a ball bearing axle extending through the body such that the reference wheel and the cutting wheel are rotatable about the ball bearing axle.

15. The glass slit cutter of claim 14, further comprising a bracket having a first end mounted to the reference wheel and a second end mounted to the cutting wheel such that rotation of the cutting wheel is synchronous with the rotation of the reference wheel.

16. The glass slit cutter of claim 14, further comprising a force applicator configured to provide a cutting force to the cutting wheel.

17. The glass slit cutter of claim 16, further comprising a solenoid to provide power to the force applicator.

18. The glass slit cutter of claim 17, wherein the solenoid is connected to the ball bearing axle.

19. The glass slit cutter of claim 18, wherein the solenoid is mounted to the second portion of the body.

20. The glass slit cutter of claim 16, further comprising a cutting wheel cantilever having a first end mounted to the ball bearing axle and a second end,
wherein the cutting wheel is mounted to the cutting wheel cantilever proximate the second end, and the force applicator is mounted to the cutting wheel cantilever proximate the second end on a side opposing the cutting wheel.
